(19) United States
(12) Patent Application Publication
(10) Pub. No.: US 2013/0110866 A1
(43) Pub. Date: May 2, 2013

(54) INFORMATION SYSTEM INCORPORATING REAL-TIME DATA SOURCES TO ENRICH CONNECTIONS AMONG USERS

(71) Applicants: Andre Furtado, Kirkland, WA (US); Tamas Sorosy, Redmond, WA (US); Oliver Szimmetat, Redmond, WA (US); David Abzarian, Kenmore, WA (US); Garett Nell, Redmond, WA (US)

(72) Inventors: Andre Furtado, Kirkland, WA (US); Tamas Sorosy, Redmond, WA (US); Oliver Szimmetat, Redmond, WA (US); David Abzarian, Kenmore, WA (US); Garett Nell, Redmond, WA (US)

(73) Assignee: MICROSOFT CORPORATION, Redmond, WA (US)

(21) Appl. No.: 13/283,623

(22) Filed: Oct. 28, 2011

(51) Int. Cl. G06F 17/30

(52) U.S. Cl. 707/769; 707/E17.014

(57) ABSTRACT

An information system is provided that uses information derived from real time data sources to identify a potential current relationship between two or more users or entities, including individuals, organizations, and groups of individuals, based on the similarity between the real data sources, and entities associated with the real time data. Given the potential for a relationship, a connection between the users can be initiated.

### BACKGROUND

One of the challenges in large organizations and other groups of people is connecting people who have common interests to enable them to work together. A variety of tools have been provided to enable such connections, such as social media networks (e.g., Facebook, Twitter), collaborative authoring tools (e.g., Wikipedia), chat tools (e.g., Microsoft's LIVE instant messenger), search tools (e.g., Bing), and other knowledge management tools and processes.

These and other information systems, such as traditional knowledge management tools and processes, are generally platforms through which users share static content or communicate directly with each other, with different tools and processes providing that content or communication in different ways.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Information systems, such as traditional knowledge management processes, generally do not fully take into account real-time information being discussed or manipulated, such as ongoing meetings, conversations, and web sessions, or real-time system information such as user presence and proximity. As a result, opportunities are missed to enable such systems to rely on more dynamic, relevant, context-aware and social sources, in which real-time knowledge generated by an individual can be employed to assist another.

An information system is provided that uses information derived from real time data sources to identify a potential current relationship between two or more users, based on similarity between the real time data sources, entities associated with the real time data, and user contexts and preferences. Given the potential for a relationship, a connection between the users can be initiated or enriched.

For example the content of currently active communications such as real time chat, emails and instant messages, can be processed to identify key topics. In turn, other users that have an interest in that topic can be identified and, for example, can be invited to join in a current conversation. For example, two real time data sources related to two different entities can be processed to identify similarities. If a desired level of similarity is reached, then a connection between those entities can be initiated or enhanced. For example, an entity can begin communicating with a matching peer, or the entities can be invited to communicate with each other, or information can be shared among those entities.

A software architecture can be provided, into which data sources capable of providing real-time information can be connected. By providing an application programming interface to which modules that access different real-time data sources can comply, such an architecture can be extensible. Such an architecture can be used to implement information systems, such as knowledge management systems, that enable users to search, add and manipulate real-time information, in addition to using static data sources. Data can be presented to users or other system components through a variety of different interfaces.

Accordingly, in one aspect, an information system receives real time data from a system, wherein the real time data includes data indicative of current interests of users (whether individuals or entities) of the system. Data indicative of a current interest of a user is received. This information can be obtained through a request from a user or derived by the system. The real time data from the system is searched to identify the users with a current relationship to the user, such as current interests similar to the user. Given the identified relationship based on real-time data, connections among the user and the other identified users can be enhanced, in a variety of ways. For example, at least one of the user and the other users can be prompted to initiate communication where the current interests are similar. Connections can be initiated or refined based on other real time data such as proximity, organizational affiliation and the like.

In one implementation, each real-time data source can be accessed through a message handler which works as an adapter to match inputs from users with the real-time data. In such an implementation, receiving the request from a user comprises a plurality of prompts and responses defining states of a message handler for a real time data source. In one implementation, data indicative of a confidence level of the message handler to respond to the request from the user is requested from a message handler for a real time data source. The system selects from among a plurality of message handlers according to the confidence level. The real time data can include state information and/or context information related to a user. Static sources can store user context data and user preferences. A federated search can be performed over multiple real time data sources to access current interests of users. Each message handler for accessing the real time data can have an interface indicative of its inputs and outputs, and the interfaces of a plurality of message handlers can be made consistent to provide for an application programming interface.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example information system.

FIG. 2 is a data flow diagram illustrating an example implementation of the information system of FIG. 1.

FIG. 3 is flowchart illustrating an example workflow with the example implementation of the information system of FIG. 2.

FIG. 4 is a block diagram of an example computing device in which such a system can be implemented.

### DETAILED DESCRIPTION

The following section provides an example operating environment in which the information system can be implemented.

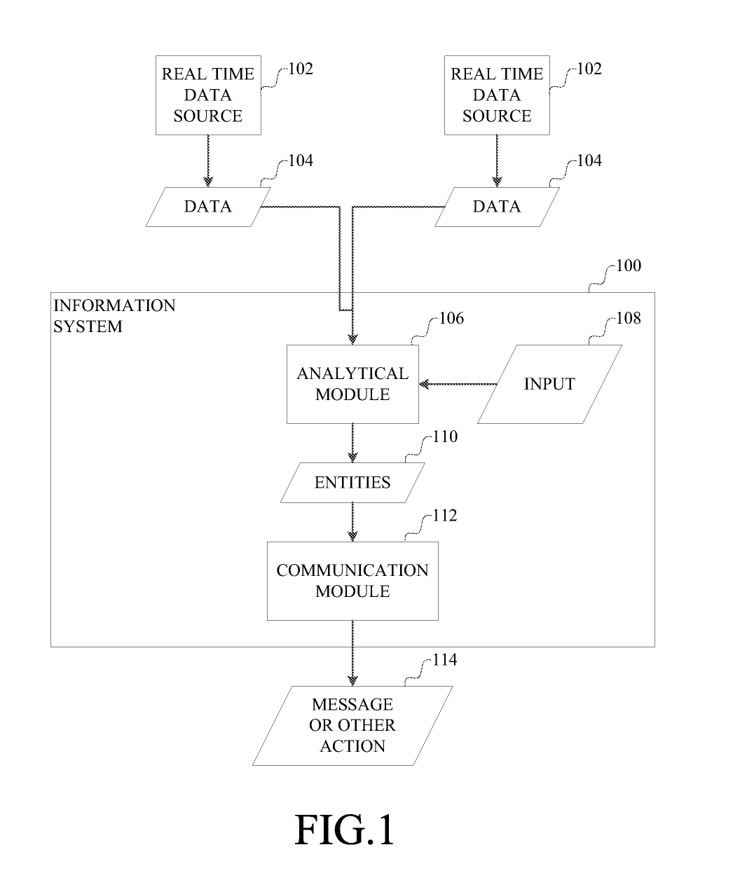

Referring to FIG. 1, an information system 100 processes data 104 from one or more real-time data sources 102, examples of which are described below. The system can, for example, receive such data, request such data and/or index such data. The information system has an analytical module 106, having an input that receives the data from the real-time data sources, which processes the data 104 according to an input 108. The input 108 specifies a search or an action or a new condition that is now satisfied, and is associated with an entity, such as an individual, or group of individuals. For example, the input could be a search for topics that an entity has a current interest in, or activities that an entity is currently engaged in, or a user context or preference that is currently set.

Data sources 102 provide information that also is associated with one or more entities. Entities include, but are not limited to, a person, group of people (such as a corporate department), object, or entity such as a business. As used herein, any “user” can be an entity. The analytical module 106 detects a potential current relationship between two or more entities (one associated with the query input and the other associated with the real-time data), using the data, state and context information from the real time data source and the input 108. When a potential for a current relationship is detected, the entities 110 associated with the data 104 are passed to a communication module 112. This module performs an action, such as sending a message 114 to at least one of the two or more entities, with whom a connection can be initiated or enhanced. For example, the entities can be invited to join in a conversation. As another example, a meeting could be scheduled between two individuals. Or, an individual can be allowed to control a system (such as heating or security) in his or her house (possibly another entity in the information system).

A real-time data source has data that varies over time, with a current state and a current context that can vary over time. There are many types of real-time data sources, such as but not limited to: communication systems that provide access to ongoing conversations (such as the text of currently transmitted instant messages and electronic mail) and related information such as a user's current status or location; online meeting systems, including information such as the current topic, current participants, current location, open tasks; workflow systems, including information such as open tasks, task status, current users and their status, current user location, resources currently being accessed, most active resources; social network systems, including information such as current user activity, status updates, and trending information; web servers, and information such as current users accessing the site, active user sessions, videos being currently watched, items currently in shopping carts of users, people currently posting information; source code control systems, including information such as files currently checked out, under merging, or under code review.

The information provided by a real-time data source thus has a current state, and is associated with an entity. Therefore, entities can be identified by searching the data associated with them and their current state. By federating real-time data sources and combining them with other sources, such a context engine is not only able to take user questions but also handle commands to update content, engage in multiple-state conversations with users towards refining their request and actively initiate dialogs according to pre-defined triggers. Such a search allows entities to be identified which appear to have a current or past interest in a particular topic, which in turn allows communication with entities currently involved in an activity to be initiated. Also, by saving state information (such as queries) of a user, this information itself becomes a real-time data source that can be preserved and searched, not only by the user in question, but by other entities in the system.

There are a multitude of different implementations that can be provided using such access to real-time data sources. Some examples are the following:

A user presents a question to an automated system, such as an online help tool, about a topic. Using real-time data, an ongoing conversation in which the topic is being discussed is identified. The user is invited to join the conversation. In a helpdesk scenario, a user can join an already ongoing session in which an expert is helping another user with a similar problem. In another scenario, users with similar questions (but no experts to answer) can be connected together so that they can share information and ideas.

A user visits an online shopping website. Using real-time data, the system can, given an item, identify other users who are online and buying the same item, i.e., users whose online shopping cart contains that given item. The system can invite the user to join a conversation with the other users to know more about the item. Game mechanics such as rewards or other social concepts can be employed to encourage users to help each other.

After watching an intriguing movie, a user can perform an online search in order to obtain more information about the movie, such as to clarify some puzzling scenes. Using real-time information, the system can connect the user not only to search results, but to other users searching for similar topics, so that they can discuss about the movie. This system can be envisioned as a dynamic, online version of “book clubs”.

A user searches for information on the internet. Based on real-time information such as the sites the user visits to look for information (web searches, news, live streaming videos, etc.), the system determines what the user is interested in. The system then can invite the user to connect with others with the same current, temporary interests, but with other resources related to that topic. Users who have previously searched for related information also may be suggested to the user currently conducting the search. The topic could be, for example, a catastrophe, and the other resources could be official sources of information related to the catastrophe.

A user is involved in computer program development, and is accessing a source control system to do code review. When performing code review, the system uses real-time data to identify other users who are reviewing the same code. The users are invited into a conversation, so that discussions about the code can occur.

A career development system can use real-time data to connect a user to ongoing meetings. For example, based on a plan of skills to acquire the system can identify meetings (real or virtual) which are ongoing or just about to start. The system could connect users currently accessing the same training materials.

An email system can identify users currently reading the same email, and enable them to communicate. For example, one user could warn another user reading the same email if a link in the email accesses malicious content.

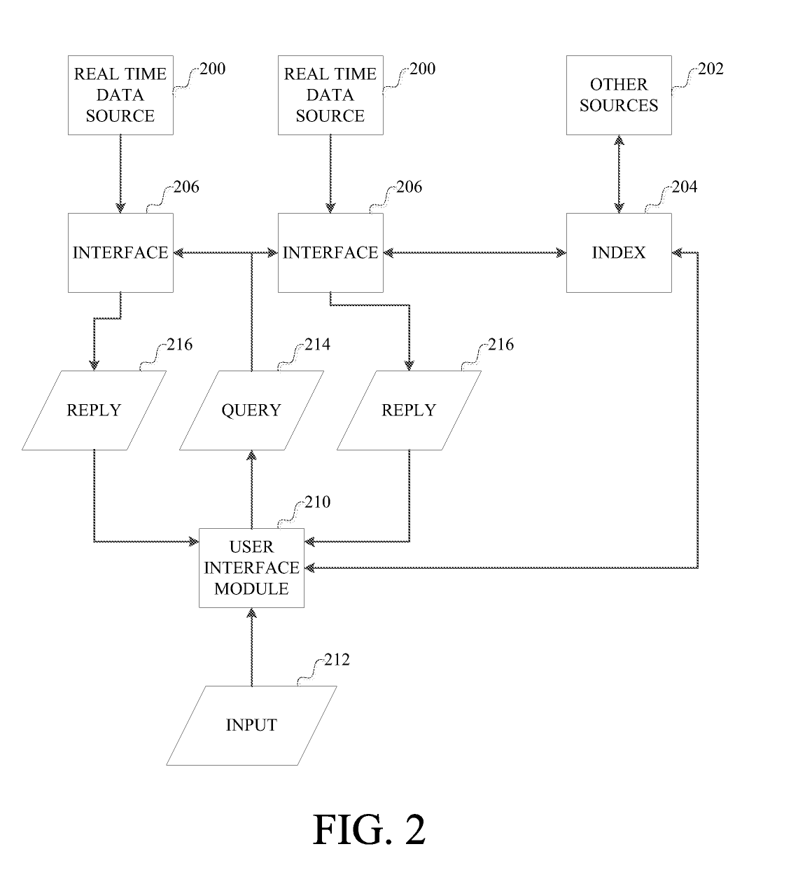

Given this context, one example implementation of such an information system will now be described in more detail in connection with FIGS. 2-4.

In FIG. 2, an information system incorporates a plurality of real-time data source processors 200, each of which is associated with a real-time data source. Each real-time data source processor 200 is designed according to the source of data that it is processing and the information desired to be retrieved from that data. Therefore the implementation details of each processor are different. The information system may include other sources 202 of data. Such a source can be, for example, any commonly used resource for knowledge management, which typically has an index 204 enabling it to be searched. Each real-time data source processor 200 implements a consistent interface 206, enabling them to be used in the same manner. This interface can be in the form of an application programming interface, and defines a pluggable or extensible architecture for interconnecting real-time data sources. In one implementation, a federated search of all of the real-time sources and other resources can be provided.

The information system also has a user interface module 210 through which a user can enter requests 212 for information. The user interface module 210 can provide any of a set of conventional tools for guiding a user through the process of specifying their request, so as to create a query 214. A query includes at least a topic and one or more target sources of data. The query 214 is submitted to one or more of the real-time source processors, which in turn provide replies 216.

There are a number of ways of implementing the connection between the user interface module 210 and the real time source processors 212. The real time source processors can reside in one or more server computers that the user interface module accesses over a computer network. The user interface module itself may reside in a machine associated with the user, or in a server computer that is accessed by one or more users over a computer network.

In one implementation, the real time source processors have an interface that receives a query, and the query is applied to data captured by the real time source processor. A federated search over multiple real time source processors is performed by providing the query to multiple such processors. In another implementation, described in more detail below, message handlers are provided for performing specific queries, and such message handlers are related to actions that a user can select to perform.

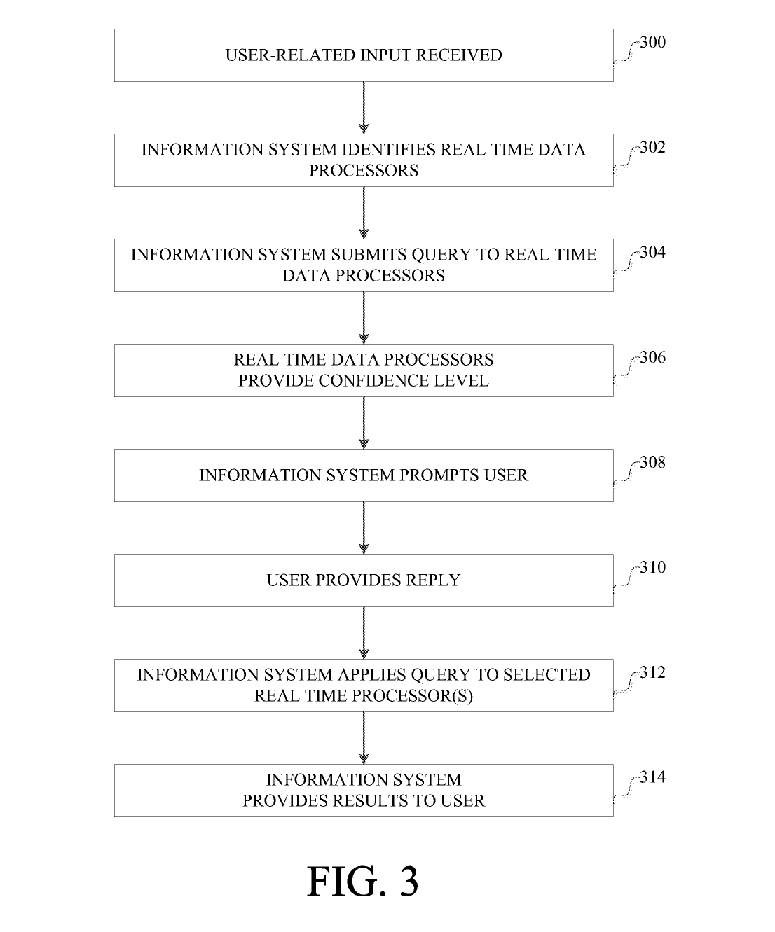

An example workflow in such a system is described by the flowchart of FIG. 3.

A user submits 300 a request to the information system. The information system identifies 302 one or more matching real-time data sources, and submits 304 the query to a processor corresponding to that source. Optionally, a confidence level is returned 306 by the processors, which in turn can be used to select one or more of the processors. For example, the system could automatically select one or more of the processors with the highest confidence levels. Or, the system could automatically select one or more of the processors based on user context or user preferences that were previously provided or that can be inferred from previous user input. As another example, the system can prompt 308 the user, to which the user can provide 310 a reply to the information system, indicating one or more of the real time source processors to use. The query is applied 312 by the selected processor to its real time data source to obtain results. Optionally the information system may obtain data from other static resources. The information system then provides 314 the results to the user. Optionally, the user can provide feedback indicating their satisfaction with the results. Such feedback also can be handled as a source of real time data, which enables the information system not only to learn, but also establish or enhance other user connections.

The results coming from the real-time data include information enabling a user to take an action to enhance a connection with an entity, such as initiate a conversation with one or more other users that have a similar interest. The user can, for example, decide whether to engage another person or group in a conversation, and request that conversation to be initiated.

Having now described the general operation of such a system, a specific example will now be described.

In this example, a real-time data source processor is a message handler that is implemented by a computer programmer to perform a specific operation on a specific real-time data source. An interface object manages interaction with the user and allows the user to provide input based on the message handlers available.

For example, a message handler can be defined that receives a help-desk ticket number, related to a request for help on a computer system. The message handler retrieves, from a help-desk database, information such as the number of requests in a queue in front of the ticket number, and topics and entities associated with the requests in the queue. The message handler in turn can identify the entities associated with topics that are similar to the topic of the user's help-desk ticket number.

Thus each message handler is specified by the input it receives, the real-time data source it accesses, and the output it provides. To implement a message handler, the message handler is programmed to process the input data, access the real-time data source using the processed input data to retrieve real-time data, derive its output from the retrieved real-time data, and then provide its output to the object calling the message handler, typically the interface object that manages interaction with the user. It should be understood that there are a variety of possible implementations of a message handler depending on the information available from the user, the real time data source, and the information to be used to connect two or more users.

In some cases, the input data related to a user can itself be derived from a real-time data source. Using the help desk example, the system could be programmed to lookup active help desk tickets for a user, so that the user does not need to remember the help desk ticket number.

The interface object is programmed to identify its associated message handlers and present an interface to the user, prompting the user for inputs that are relevant to the message handlers available.

In addition to the functionality above, a message handler also can be programmed to provide a confidence level in response to an input provided. A confidence level can be implemented using any of a variety of ranges or sets of values. One example is a range of values from 0 to 1, with one indicating strong confidence. In this case, a message handler can determine, for example, if its data source is available, and indicate a confidence of level of “1” if the database is available and a confidence level of “0” if the database is unavailable. As another example, the confidence level can be based on the ability of the processor understand the user request. For example, if the request is in the form of natural language question, then the confidence level can be based on a measure of confidence that the natural language expression is properly understood by the processor.

In such an implementation, the interface object passes a message to a message handler and initially receives its confidence level information. The interface object can select, or can prompt the user to select, a message handler based on the confidence level information provided.

A message handler also can be programmed to implement multiple states. Such states can correspond to conversational states relating to the interaction with the user. In one implementation, a message handler maintains data indicating its current “state handler” for a specific user interaction. A message handler can have an instance for each user interaction, and thus multiple instances, each with its own state. The reply generated by the message handler is determined at least in part by its current state handler. Other variables can be taken into account, such as entity context and the real-time data itself. If a message handler implements multiple states, then the replies generated also can include a prompt for additional information from the user.

Other information gathered in the other states can be maintained by the message handler, thus providing ongoing developing context for the conversation with the message handler. Any of the collected context information can be used for further identifying other entities with whom to communicate.

The interface object, in this example with a message handle with multiple states, processes replies from a message handler and presents any prompts to the user. In response to the user providing further input, this additional input is passed to the message handler.

Such stateful message handlers can be used to implement the process of enhancing connections among using, such as initiating communication among users or taking other actions. For example, a reply from a message handler can indicate that there are a number of users currently discussing the same topic, prompt the user as to whether any communication with those users is desired.

The message handlers, or the systems they access, also can implement appropriate privacy mechanisms as desired.

Having now described an example implementation it should be understood that the foregoing is merely an example of how to implement such an information system. There are many ways in which a real time data source can be processed to access information about the current interests of users currently using a system, and in turn use that information to identify users with related interests and enable them to initiate communication with each other.

In addition to retrieving real-time information to enhance connections among users with related interests, the system also provides a variety of other benefits. By providing a consistent interface for accessing multiple real-time data sources, searched can be federated over multiple sources, allowing users to interact with a single source to manage real-time information.

Also, in the example implementation described above, each message handler associated with a real time data source provides a confidence level for handling a given user request, enabling a best message handler to be selected. Feedback from a user allows a different message handler to be selected.

Also, in the example implementation described above, the information system can establish and track a conversational state, building a context for the user request and refining it after each interaction. The system can be implemented to ask clarifying questions, offer options for the user to choose from, set expectations or even take actions in a later moment, pushing notifications or following up. As a result, an information management task is not atomic and may just be setting the context for future tasks by keeping state information during a session.

Having now described an example implementation, a computing environment in which such a system is designed to operate will now be described. The following description is intended to provide a brief, general description of a suitable computing environment in which this system can be implemented. The system can be implemented with numerous general purpose or special purpose computing hardware configurations. Examples of well known computing devices that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

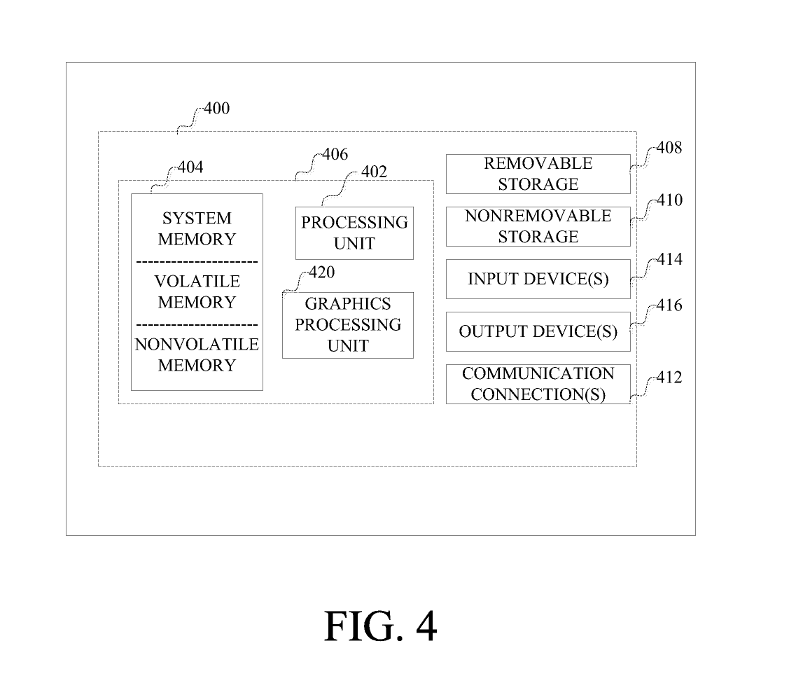

FIG. 4 illustrates an example of a suitable computing system environment. The computing system environment is only one example of a suitable computing environment and is not intended to suggest any limitation as to the scope of use or functionality of such a computing environment. Neither should the computing environment be interpreted as having any dependency or requirement relating to any one or combination of components illustrated in the example operating environment.

With reference to FIG. 4, an example computing environment includes a computing machine, such as computing machine 400. In its most basic configuration, computing machine 400 typically includes at least one processing unit 402 and memory 404. The computing device may include multiple processing units and/or additional co-processing units such as graphics processing unit 420. Depending on the exact configuration and type of computing device, memory 404 may be volatile (such as RAM), non-volatile (such as ROM, flash memory, etc.) or some combination of the two. This most basic configuration is illustrated in FIG. 4 by dashed line 406. Additionally, computing machine 400 may also have additional features/functionality. For example, computing machine 400 may also include additional storage (removable and/or non-removable) including, but not limited to, magnetic or optical disks or tape. Such additional storage is illustrated in FIG. 4 by removable storage 408 and non-removable storage 410. Computer storage media includes volatile and nonvolatile, removable and non-removable media implemented in any method or technology for storage of information such as computer program instructions, data structures, program modules or other data. Memory 404, removable storage 408 and non-removable storage 410 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing machine 400. Any such computer storage media may be part of computing machine 400.

Computing machine 400 may also contain communications connection(s) 412 that allow the device to communicate with other devices. Communications connection(s) 412 is an example of communication media. Communication media typically carries computer program instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media.

Computing machine 400 may have various input device(s) 414 such as a keyboard, mouse, pen, camera, touch input device, and so on. Output device(s) 416 such as a display, speakers, a printer, and so on may also be included. All of these devices are well known in the art and need not be discussed at length here.

Such a system may be implemented in the general context of software, including computer-executable instructions and/or computer-interpreted instructions, such as program modules, being processed by a computing machine. Generally, program modules include routines, programs, objects, components, data structures, and so on, that, when processed by a processing unit, instruct the processing unit to perform particular tasks or implement particular abstract data types. This system may be practiced in distributed computing environments where tasks are performed by remote processing devices that are linked through a communications network. In a distributed computing environment, program modules may be located in both local and remote computer storage media including memory storage devices.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process comprising:
receiving real time data from a system, wherein the real time data includes data indicative of current interests of users of the system;
receiving data indicative of a current interest of a user; and
searching the real time data from the system to identify one or more other users with current interests similar to the user; and
enhancing a connection between the user and at least one of the other identified users.

2. The computer-implemented process of claim 1, wherein receiving data comprises a plurality of prompts and responses defining states of a message handler for a real time data source.

3. The computer-implemented process of claim 1, further comprising:
requesting from a message handler for a real time data source an indicative of a confidence level of the message handler to respond to a request from the user.

4. The computer-implemented process of claim 3, wherein there are a plurality of message handlers and the process further comprising:
selecting from among a plurality of message handlers according to the confidence level.

5. The computer-implemented process of claim 1, wherein the real time data includes state information related to a user.

6. The computer-implemented process of claim 5, further comprising:
storing the state information; and
searching the stored state information in subsequent searches of real time data sources.

7. The computer-implemented process of claim 1, wherein the real time data includes context information related to a user.

8. The computer-implemented process of claim 1, further comprising using a message handler to access each real time data source, wherein each message handler has an interface indicative of its inputs and outputs, and wherein the interfaces of a plurality of message handlers is consistent.

9. The computer-implemented process of claim 1, wherein the data indicative of the current interest of the user is provided by a user request.

10. The computer-implemented process of claim 1, wherein the data indicative of the current interest of the user is inferred by an information system from user interaction with the information system.

11. An article of manufacture comprising:
a computer storage medium;
computer program instructions stored on the computer storage medium which, when processed by a processing device, instruct the processing device to perform a process comprising:
receiving data indicative of a current interest of a user; and
searching the real time data from the system to identify one or more other users with current interests similar to the user; and
enhancing a connection between the user and at least one of the other identified users.

12. The article of manufacture of claim 11, wherein receiving comprises a plurality of prompts and responses defining states of a message handler for a real time data source.

13. The article of manufacture of claim 11, further comprising:
requesting from a message handler for a real time data source an indicative of a confidence level of the message handler to respond to a request from the user.

14. The article of manufacture of claim 13, wherein there are a plurality of message handlers and the process further comprising:
selecting from among a plurality of message handlers according to the confidence level.

15. The article of manufacture of claim 11, wherein the real time data includes state information related to a user.

16. The article of manufacture of claim 15, wherein the process further comprises storing the state information and searching the stored state information in subsequent searches of real time data sources.

17. The article of manufacture of claim 11, wherein the real time data includes context information related to a user.

18. The article of manufacture of claim 11, further comprising using a message handler to access each real time data source, wherein each message handler has an interface indicative of its inputs and outputs, and wherein the interfaces of a plurality of message handlers is consistent.

19. The article of manufacture of claim 11, wherein the data indicative of the current interest of the user is provided by a user request.

20. The article of manufacture of claim 1, wherein the data indicative of the current interest of the user is inferred by an information system from user interaction with the information system.
